(19) United States
(12) Patent Application Publication
(10) Pub. No.: US 2013/0109374 A1
(43) Pub. Date: May 2, 2013

(54) System and Method for a Display Unit Coupled to a Smartphone

(71) Applicant: Young Hoon Kwon, San Diego, CA (US)

(72) Inventor: Young Hoon Kwon, San Diego, CA (US)

(21) Appl. No.: 13/285,966

(22) Filed: Oct. 31, 2011

(51) Int. Cl. H04W 88/06

(52) U.S. Cl. 455/426.1

(57) ABSTRACT

An embodiment of a system that couples a display device to a smartphone includes a smartphone and display device. The smartphone is formed with a short-range module configured to transmit image data for an image produced on the smartphone display. The short-range module can be a wired or wireless module. The display device is formed with a corresponding module configured to receive the image data and a touch screen to enable an operator to control the display device. The processor unit of the smartphone is configured to provide a processing function to control both the smartphone and the display device. The smartphone and the display device can further include graphic process modules to compress and decompress the image data.

### TECHNICAL FIELD

The present invention relates generally to a system and method coupling electronic devices, and, in particular embodiments, to a system and method for a display unit coupled to a smartphone.

### BACKGROUND

Tablets and smartphones are currently designed for particular end users, and many internal components can be used in either tablets or smartphones. A main difference between tablets and smartphones is obviously the size of the screen. Other than screen size, from the perspective of an end user, buying both a tablet and a smartphone is expensive, not just from initial device costs, but also due to separate monthly maintenance expenses. The ability to provide overlapping functionality between a tablet and a smartphone without incurring unnecessary cost and duplicate maintenance expenses would answer a market need.

### SUMMARY OF THE INVENTION

An embodiment of a system that couples a display device to a smartphone includes a smartphone and a display device. The smartphone is formed with a short-range wired or wireless module configured to transmit image data for an image produced on the smartphone display to the display device. The display device is formed with a corresponding short-range module configured to receive the image data and a touch screen to enable an operator to control the display device and the smartphone. The processor unit of the smartphone is configured to provide a processing function to control both the smartphone and the display device. The smartphone and the display device can further include graphic process modules to compress and decompress the image data.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1 and 2 illustrate block diagrams of a smartphone that communicates over a short-range link with a tablet, in accordance with an embodiment;

FIG. 3 illustrates a block diagram of a processing system that may be used in accordance with an embodiment; and

FIG. 4 is a graphical representation of a method to couple a smartphone to a display device, according to the principles of an embodiment.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

As introduced herein, a smartphone and a separate display device for the smartphone are bidirectionally connected over a short-range communication link, such as a short-range wired communication link or a short-range wireless communication link, such as a Wi-Fi communication link. Short-range wireless connectivity conventionally available in smartphones and tablets is employed so that the display device can operate as a display for the smartphone and the display device can also use processing power of the smartphone when the smartphone is close to the display device. A tablet is generally formed with a touch screen, and the input/output capability of a tablet is retained for use as a display device for a smartphone when the display device is wirelessly connected to the smartphone. Alternatively, the display device can be connected to the smartphone over a wired communication link. The display device, relying on processing power of the smartphone, can thus be formed with less processing capability.

Although embodiments described herein can employ a wireless communication connection between a smartphone and a display device to utilize the larger display of the display device for use with the smartphone, a wired metallic connection is also contemplated within the broad scope of the present invention. A display device in the form of a tablet is described. It is also contemplated that a computer display/monitor formed with short-range wireless communication capability can be used as a display device to supplement the display capability of a smartphone.

The size of the display screen for tablets and smartphones makes a substantial difference in a user's experience. One device size for both smartphones and tablets generally would not satisfy diverse end users' experience in view of the way such devices are carried and used. Tablets are obviously less conveniently transportable due to their larger size. Smartphones, being smaller, easily fit into a person's pocket, holster, or purse. However, a tablet incurs substantial expense for its purchase due to the extensive processing capability ordinarily provided in its design.

Other than screen size, many of the components of a smartphone and a tablet can be shared. A display device with reduced processing capability that relies on a processor in a smartphone can be used in conjunction with the smartphone to take advantage of the larger display screen of the display device without incurring unnecessary consumer expense.

As introduced herein, a smartphone and a display device are connected by a short-range wired or wireless communication link, for example by a wireless Wi-Fi communication link, to combine their functionality. The functionality of the smartphone is retained to provide a point of cellular wireless connectivity, and the display capability of a tablet is retained to provide a larger viewable area. The “touch screen” or other form of manual data input/output capability of a tablet is also retained in the display device so that the input/output capability of a tablet operating as a display device is preserved. Two-way communication is established between the smartphone and the display device. Information produced by the smartphone is displayed on the display device, and touch-screen inputs produced by a user on the display device are communicated to the smartphone. Multi-tasking on multiple screens is thereby achieved.

A smartphone and a conventional tablet both generally have short-range wireless communication capability. Accordingly, a display device for a smartphone uses the processing capability of the smartphone when the smartphone is close to the display device, e.g., within the communication range of a short-range wireless system such as Wi-Fi or Bluetooth.

The smartphone retains its normal functionality, including a short-range wireless module, a human input interface device such as a touch screen to enable an operator to control the display device display, a display controller, a touch screen controller, a power module, and a battery. By using the short-range wireless module of a smartphone and a display device wirelessly coupled to the smartphone, input/output information can be conveyed to a user in a more convenient and satisfying way. Alternatively, the communication path between the smartphone and the display device can be a wired connection.

A smartphone operating in a conventional mode employs its normal feature content, including the full input/output (“I/O”) capability of its display. When the smartphone is connected over a short-range communication link to display device, input/output capability of a conventional tablet is retained such that the display device with limited processing capability can operate as a complete tablet. For the smartphone, cellular, Wi-Fi, internal sensors, and the central processing unit (“CPU”) therein are retained and coupled to processing elements of the display device to provide access and usage equivalent to that of a complete tablet with more complex processing capability.

Simultaneous input and output on both the smartphone and the display device are accessible and available. The operating system (“OS”) of the smartphone is configured to support multi-tasking such that independent tasks can be performed on the coupled smartphone and display device at the same time. For example, a voice call can be made with the smartphone and Internet surfing can be simultaneously performed on the display device. Thus, Internet surfing is performed via the smartphone while e-reading and gaming are performed on the display device.

A short-range wired or wireless module can be used for both an Internet connection and data transfer between the smartphone and the display device such that unnecessary implementation costs or size increase for the smartphone or display device is needed. A currently available short-range wireless module such as one that conforms to one of the group of IEEE standards 802.11 already supports multiple connection features.

To reduce the required bandwidth for video transfer between the smartphone and the display device, the display device can be supported by a graphic process module so that compressed video information can be conveyed wirelessly or over a wired path between the two devices.

The smartphone can determine, e.g., periodically, if a display device is nearby and turned on. Once the smartphone finds an active display device, the connection between the smartphone and the display device is done automatically. Once the connection between two modules is made, the OS in the smartphone automatically adjusts the user interface accordingly.

When both the smartphone and the display device are on, a user can use the smartphone screen as an auxiliary screen for the display device. Alternatively, both screens can be configured in an extended screen mode.

The display device can be powered on and used as a simple independent picture frame without being connected to a smartphone. Thus, when a user does not carry the display device, it can be used as an interior picture frame.

A display device coupled to a smartphone can thus serve two purposes. The display device can be thin and sleek because the display device can be assembled with fewer parts than a conventional tablet, and there is less need to increase the size of the display of the smartphone.

The form factor of the smartphone need not be compromised. When there is an incoming or outgoing call during display device usage, a user can use the smartphone for a voice call while continuing Internet usage on the display device without the need for a wireless headset such as a Bluetooth headset. In this manner, the smartphone is used for voice and the display device is used for Internet purposes.

Simultaneous usage by two persons of the smartphone and the display device can be supported. Dual screen operation enables better usage of the display device and smartphone.

Embodiments thus provide a smartphone coupled to a display device over a short-range communication link to enable the display device to be operable as a display device for the smartphone. The result is improved user experience for the smartphone and the display device without the need to incur additional monthly charges.

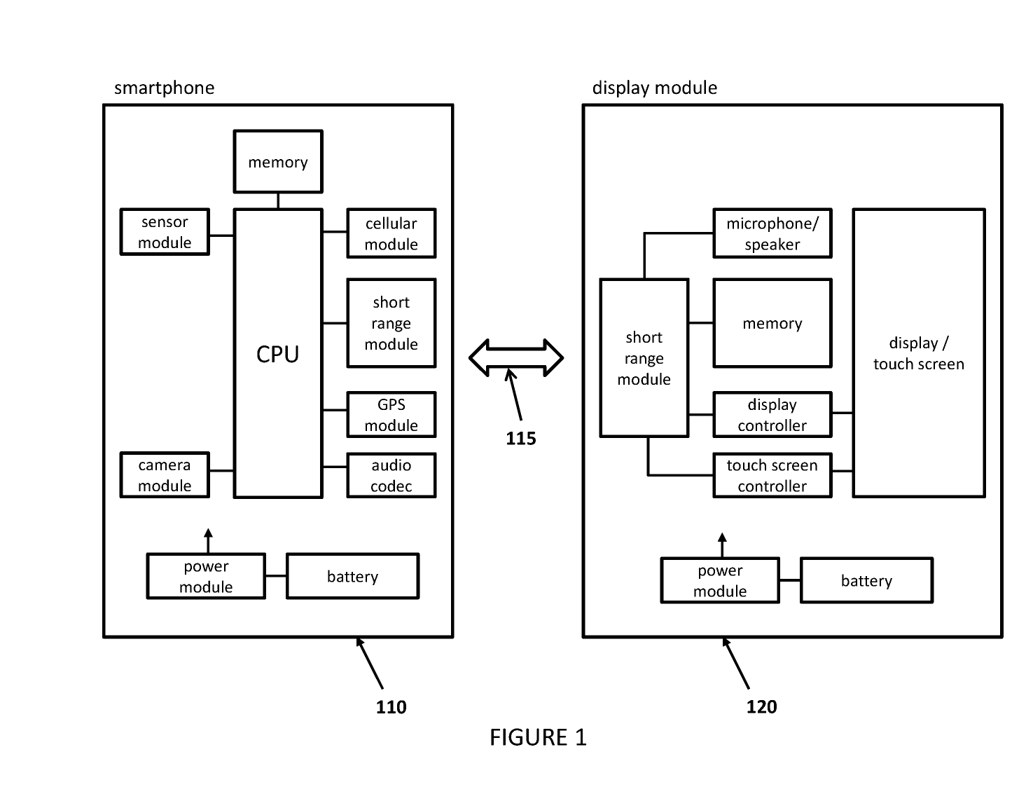

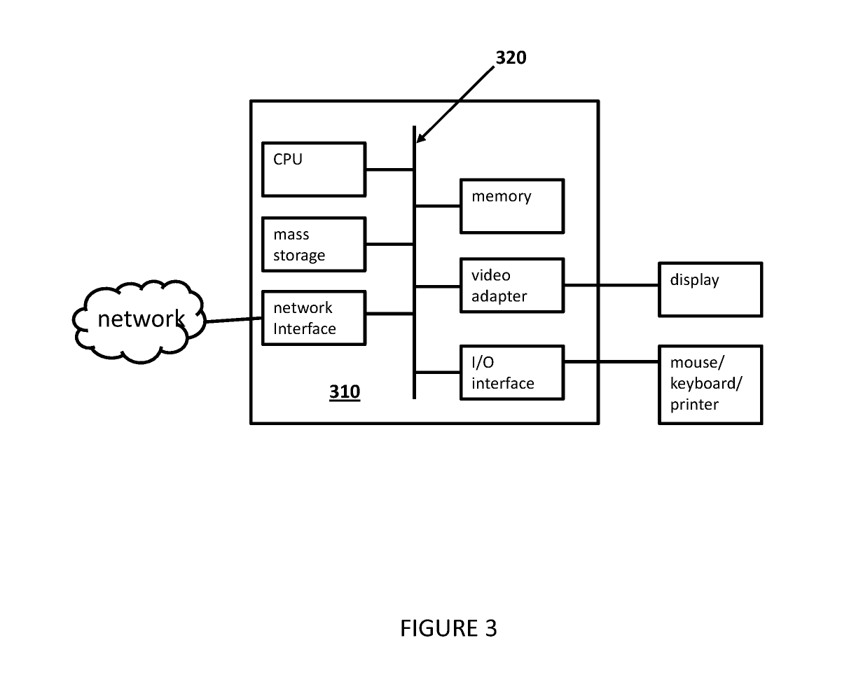

Turning now to FIG. 1, illustrated is a block diagram of a smartphone 110 that communicates over a short-range wired or wireless bidirectional link 115 with a display device 120, in accordance with an embodiment. The smartphone 110 is formed with a processor, memory, sensor module, cellular module, short-range module such as a short-range wired or wireless module, global positioning system (“GPS”) module, audio codec, and a power module and battery to provide the necessary bias voltages for other components. The short-range module in the smartphone 110 provides the bidirectional link 110 with display device 120. The bidirectional link 110 can be, without limitation, a Wi-Fi link, a Bluetooth link, or a wired link. The smartphone 110 may be formed with further elements as described hereinbelow with reference to FIG. 3.

The display device 120 is formed with a human input interface device such as a touch screen to enable an operator to control the display device, a display controller, a touch screen controller, a microphone/speaker, and a short-range wired or wireless module. In addition, the display device 120 is formed with a power module and a battery to provide the necessary bias voltages for other components. The bidirectional wired or wireless link 115 enables the display device 120 to display information ordinarily presented on the display of a smartphone in a larger area than that provided by a smartphone, and to communicate touch-screen inputs to the smartphone. The display device 120 may be formed with further elements as described hereinbelow with reference to FIG. 3.

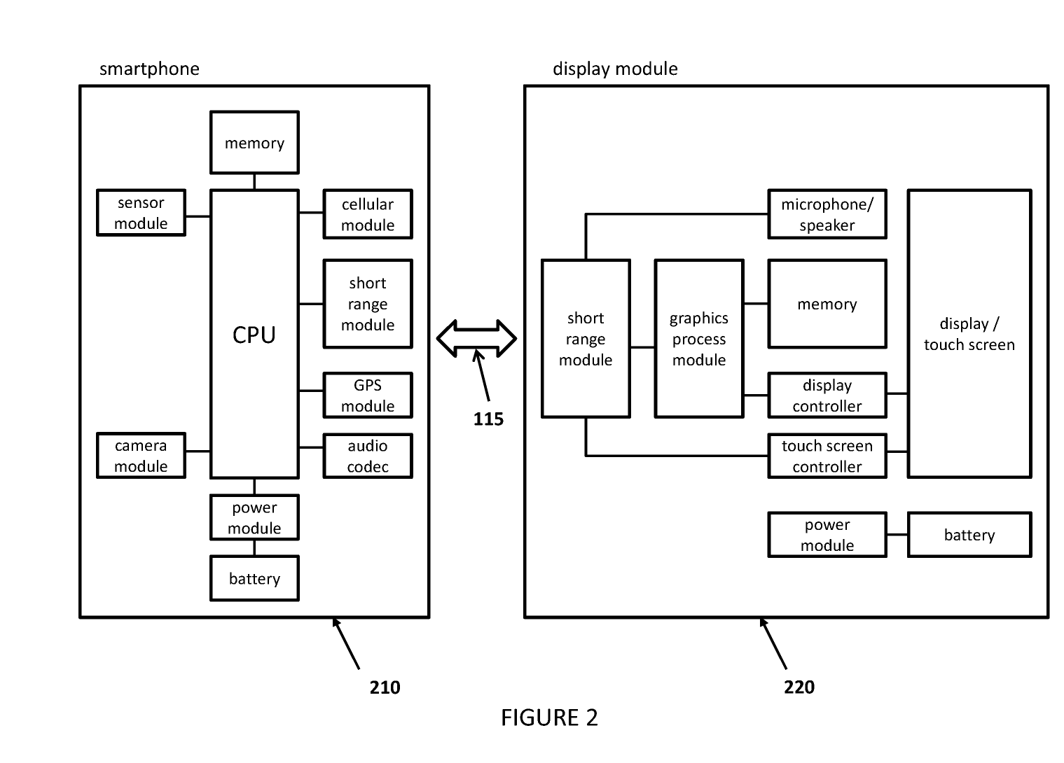

Referring now to FIG. 2, illustrated is a block diagram of a smartphone 210 that communicates over a short-range bidirectional wired or wireless link 115 with a display device 220, in accordance with an embodiment. The display device 220 illustrated in FIG. 2 is formed with a graphic process module so that compressed video information is conveyed between the smartphone 210 and the display device 220. The smartphone 210 and the display device 220 may be formed with further elements as described hereinbelow with reference to FIG. 3.

It is noted that, unless indicated otherwise, functions described herein can be performed in either hardware or software, or some combination thereof, with or without human intervention. In an embodiment, the functions are performed by a processor such as a computer or an electronic data processor, such as that discussed below with reference to FIG. 3, in accordance with code such as computer program code, software, and/or integrated circuits that are coded to perform such functions, unless indicated otherwise.

Referring now to FIG. 3, illustrated is a block diagram of elements of a processing system that may be used to perform one or more of the processes discussed above. The processing system may comprise a processing unit 310 equipped with one or more input/output devices, such as a mouse, a keyboard, printer, or the like, and a display. The processing unit 310 may include a central processing unit (CPU), memory, a mass storage device, a video adapter, a network interface, and an I/O interface connected to a bus 320.

The bus 320 may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for data storage for use while executing programs.

The mass storage device may comprise any type of storage device configured to store data, programs, and other information and to make the data, programs, and other information accessible via the bus. The mass storage device may comprise, for example, one or more of a hard disk drive, a magnetic disk drive, an optical disk drive, or the like.

The video adapter and the I/O interface provide interfaces to couple external input and output devices to the processing unit. Examples of input and output devices include the display coupled to the video adapter and the mouse/keyboard/printer coupled to the I/O interface. Other devices may be coupled to the processing unit, and additional or fewer interface cards may be utilized. For example, a serial interface card (not shown) may be used to provide a serial interface for a printer.

The processing unit also preferably includes a network interface, which can be a wired link, such as an Ethernet cable or the like, and/or a wireless link to enable communication with a network such as a cellular communication network. The network interface allows the processing unit to communicate with remote units via the network. In an embodiment, the processing unit is coupled to a local-area network or a wide-area network to provide communications to remote devices, such as other processing units, the Internet, remote storage facilities, or the like.

It should be noted that the processing system may include other components. For example, the processing system may include power supplies, cables, a motherboard, removable storage media, cases, and the like. These other components, although not shown, are considered part of the processing system.

In a normal smartphone, there wiring exists between a processor and input/output modules such that processor's response for a display can be delivered toward the display controller and finally to the display. Similarly, an end user's touch on a touch screen is delivered first to the touch screen controller and then to the processor. As introduced herein, a short-range wireless module is substituted for the wiring part. Thus, in terms of input/output data transfer, there is no difference between using a short-range wireless module and using conventionally wired bus.

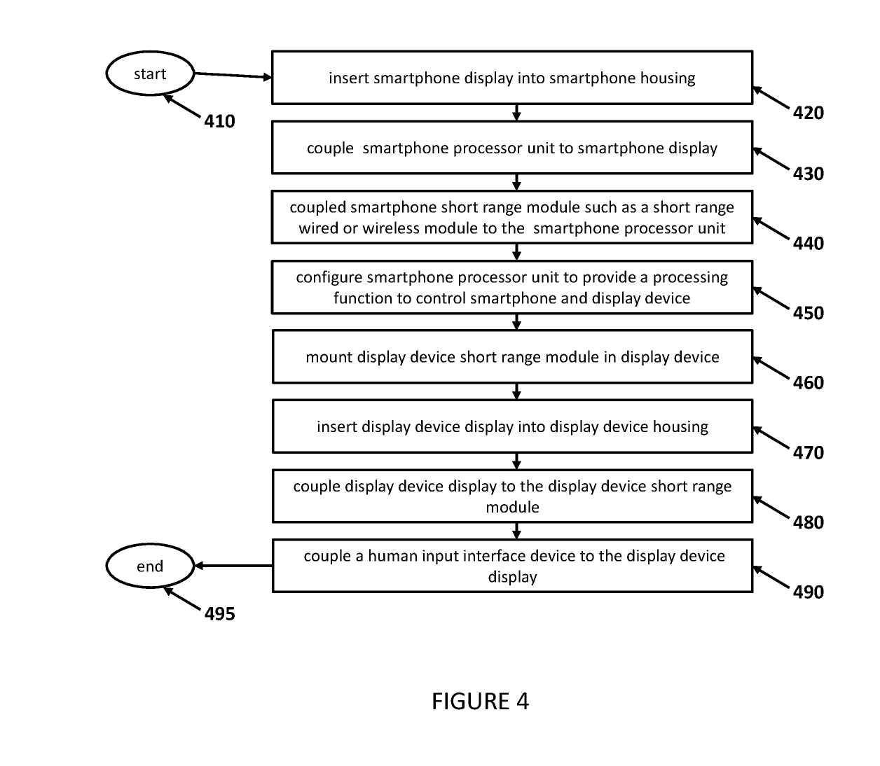

Turning now to FIG. 4, illustrated is a graphical representation of a method to couple a smartphone to a display device, according to the principles of an embodiment. The method functionally begins in a step or module 410. In step or module 420, a smartphone display is inserted into a smartphone housing. In step or module 430, a processor unit in the smartphone is coupled to the smartphone display. In step or module 440, a short-range wired or wireless module in the smartphone is coupled to the processor unit to transmit image data for an image produced on smartphone display. In step or module 450, the processor unit is configured to provide a processing function to control the smartphone and a display device coupled over a short-range wired or wireless communication link. In step or module 460, to form the display device, a display device short-range wired or wireless module is mounted in the display device to receive the image data. In step or module 470, a display device display is inserted into a display device housing. In step or module 480, the display device display is coupled to the display device short-range module to display the image. In step or module 490, a human input interface device such as a touch screen is coupled to the display device display to enable an operator to control the display device. The method functionally ends in step or module 495.

Coupling a smartphone to a display device can be described further as follows. There can be two independent actions available at a display device: a touch screen input and a display output. Thus, actions at the smartphone and display device for these two actions can be considered independently.

For a touch screen input, when an end user touches the screen, the “touch” action is converted into an electric signal at the “touch screen” part. This electric signal related to the touch action is converted to useful data such as a touch position, touch movement, etc., at the touch screen controller. The touch screen controller delivers these data to a short-range wired or wireless module. The short-range module in the display device can be wirelessly connected to the smartphone using short-range wireless protocols such as specified in one of the group of IEEE standards 802.11. To conserve energy at the display device, the short-range module can remain in a sleep mode if there is no data input from the touch screen controller depending on the used protocol. When the touch screen controller delivers a touch input data to the short-range module, this data is encapsulated on top of an underlying short-range wireless protocol and delivered to the smartphone.

If the short-range module in the display device is not yet connected to the smartphone, then touch input data from the touch screen controller initiates an association/connection process, such as a wireless association/connection process, to the smartphone. After receiving data at the short-range module in the smartphone, it removes the underlying short-range protocol and recovers the encapsulated data. When the short-range module in the smartphone acknowledges incoming data from the display device, it communicates with and delivers the incoming data to the processor.

For the display device, the processor in the smartphone handles data processing for both the smartphone and the display device. When the processor in the smartphone generates new display output for the screen of the display device, this display information is delivered to the short-range module in the smartphone. When the processor in the smartphone delivers display data to the short-range module, this data is encapsulated on top of an underlying short-range protocol and delivered to display device. After receiving data at the short-range module in the display device, it removes the underlying short-range protocol and recovers the original encapsulated data. When the short-range module at the display device acknowledges incoming data from smartphone, it communicates with the display controller of this event. Then, the display controller compiles this information and coverts it to a signal that can be displayed on the display of the display device. Finally, the display device displays the corresponding output on the display.

Multiple connection features of IEEE specification 802.11 can be employed to establish simultaneous wireless connections between a wireless router and the smartphone and between the smartphone and the display device.

A possible protocol for a short-range wireless module is IEEE specification 802.11. A current IEEE specification 802.11 protocol supports various features that enable simultaneous wireless connections between a wireless router and a smartphone and between the smartphone and a display device.

An example of such a feature is the “Wi-Fi Direct” feature. By using the Wi-Fi Direct feature, a Wi-Fi module in a smartphone can act as a client to the wireless router and at the same time it can act as an independent router. Thus, the Wi-Fi module in a display device can be connected and associated with the smartphone, and treated as a router. In this manner, a Wi-Fi module in a smartphone can simultaneously establish wireless connections between a wireless router and a smartphone and between the smartphone and the display device.

In an embodiment, the processor unit in the smartphone coordinates with a graphics processor unit or module (“GPU”) over the short-range connection. Instead of transmitting “display-ready” information to the display device, the processor unit in the smartphone sends compressed display information and related control information, mainly to reduce the required bandwidth for the short-range link. The amount of data and control information depends on a compression method and data format. At an initial stage when the display device is first set up and connected over a short-range link to the smartphone, the processor unit in the smartphone identifies the display information of the display device such as display size, number of pixels, aspect ratio, supporting display information and data format, data interface, etc. Thus, when the display device is connected to the smartphone over a short-range link, the processor unit in the smartphone acknowledges the required data format and compression method.

At the display device, after receiving the display—related information by short-range module, the GPU decodes the control information and then processes corresponding processing/data decoding to extract display-ready information. Finally, the display-ready information is delivered to the display controller and it is displayed on the display panel of the display device.

Embodiments such as those presented herein provide a system and a method for bidirectionally connecting a smartphone and a display device over a short-range communication link such as a Wi-Fi, Bluetooth, or other short-range communication link. For example, embodiments such as those disclosed herein can provide a system constructed with a smartphone and display device. The smartphone is formed with a smartphone display, a processor unit, and a smartphone short-range module configured to transmit image data for an image produced on the smartphone display. The display device is formed with a display device short-range module configured to receive the image data for the image produced on the smartphone display, a display device display to display the image, and a human input interface device to enable an operator to control the display device. The processor unit of the smartphone is configured to provide a processing function to control both the smartphone and the display device. The human input interface device can be, without limitation, a touch screen apparatus, a keyboard, or a touch-pad.

The smartphone can further include a smartphone graphic process module to compress the image data, and the display device can further include a display device graphic process module to decompress the image data.

The smartphone short-range module is configured to transmit the image data over a Wi-Fi, Bluetooth, wired, or other short-range communication link.

The display device short-range wireless module is configured to transmit data produced by the human input interface device to the smartphone short-range module, and the smartphone is can be configured to process the data produced by the human input interface device.

The smartphone display and the display device display are configured to operate in an extended screen mode or in an independent screen mode.

The display device is configured to operate in a mode independent of an operating mode of the smartphone.

The smartphone short-range module can be configured to automatically attempt, e.g., periodically, to establish a connection with the display device to display the image on the display device display.

Sensor data produced by sensors in the smartphone can be employed to perform functions in the display device.

The operating system in the smartphone is configured to support multi-tasking to enable independent use of the smartphone and the display device when the smartphone and the display device are wirelessly coupled or wired together.

The smartphone short-range module and the display device short-range module are configured to cooperate to enable data transfer between the smartphone and the display device operating as a display for the smartphone.

In an embodiment, a smartphone is formed with a cellular wireless module, a display, and a short-range wired or wireless module configured to transmit image data received by the cellular wireless module and to receive manually input data transmitted by a display device. The smartphone is further configured to respond to the manually input data, and a processor unit therein is configured to provide a processing function for both the smartphone and the display device.

The smartphone further includes a graphic process module configured to compress the image data transmitted by the short-range module.

The short-range module in the smartphone is configured to support a Wi-Fi, Bluetooth, wired, or other short-range communication link.

The smartphone is further configured to employ the short-range module to communicate with a display device to operate the display of the smartphone in an extended screen mode with a display of the display device.

The short-range wired or wireless module of the smartphone automatically attempts to establish a connection with a display device to display data thereon.

In an embodiment, a display device is formed with a display, a display controller to process display data, a human input interface device to enable an operator to manually input data to the apparatus, and a short-range module configured to receive image data transmitted by a smartphone to enable the image to be displayed on the display. The short-range module of the display device can be configured to provide a wired or wireless connection with a smartphone. The short-range module of the display device is further configured to transmit the manually input data. The display device apparatus employs a processor unit in the smartphone to provide a general processing function for its control.

The short-range module in the display device is configured to support a Wi-Fi, Bluetooth, wired, or other short-range communication link.

The display device is further configured to operate its display in an extended screen mode with a smartphone display, wherein display data is received by the short-range module of the display device.

The short-range module of the display device automatically, e.g., periodically, establishes a short-range communication link with a smartphone to acquire image data to be displayed on the display of the display device.

The display device employs sensor data produced by sensors in the connected smartphone to perform a function in the display device.

The display device can be configured to operate in a mode independent of an operating mode of the smartphone.

An embodiment of a method of forming a system includes forming a smartphone display device. Forming the smartphone includes inserting a smartphone display into a housing for the smartphone, coupling a processor unit to the smartphone display, and coupling a smartphone short-range module to the processor to transmit image data for an image produced on the smartphone display. Forming the smartphone further includes configuring the processor unit to provide a processing function to control the smartphone and a display device.

Forming the display device includes inserting a display device display into a display device housing with a display device short-range module to receive the image data. Forming the display device further includes coupling the display device display to the display device short-range module to display the image, and coupling a human input interface device to the display device display to enable an operator to control the display device.

Forming the smartphone can further include coupling a smartphone graphic process module to the processor unit to compress the image data. Forming the display device can further include coupling a display device graphic process module to the display device short-range module to decompress the image data.

An embodiment of a method of operating a system including a smartphone and a display device includes transmitting, by the smartphone, image data for an image produced on a smartphone display of the smartphone, receiving at the display device the image data for the image produced on the smartphone display, displaying the image at a display device display of the display device, and controlling, by a processor in the smartphone, the smartphone and the display device. The method can further include receiving, at the smartphone, manually input data transmitted by the display device, and processing, at the smartphone, the manually input data.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system comprising:
a smartphone comprising:
a smartphone display,
a processor unit, and
a smartphone short-range module configured to transmit image data for an image produced on the smartphone display; and
a display device comprising:
a display device short-range module configured to receive the image data for the image produced on the smartphone display,
a display device display to display the image, and
a human input interface device to enable an operator to control the display device, wherein the processor unit is configured to provide a processing function to control the smartphone and the display device.

2. The system as recited in claim 1, wherein the human input interface device comprises at least one of a touch screen apparatus, a keyboard, and a touch-pad.

3. The system as recited in claim 1, wherein the smartphone further comprises a smartphone graphic process module configured to compress the image data and the display device further comprises a display device graphic process module configured to decompress the image data.

4. The system as recited in claim 1, wherein the smartphone short-range module is configured to transmit the image data wirelessly over a communication link.

5. The system as recited in claim 1, wherein the display device short-range module is further configured to transmit data produced by the human input interface device to the smartphone short-range module, and the smartphone is further configured to process to the data produced by the human input interface device.

6. The system as recited in claim 1, wherein the smartphone display and the display device display are configured to operate in an extended screen mode.

7. The system as recited in claim 1, wherein the smartphone display and the display device display are configured to operate in an independent screen mode.

8. The system as recited in claim 1, wherein the smartphone short-range module is configured to automatically attempt to establish a connection with the display device to display the image on the display device display.

9. The system as recited in claim 1, wherein the display device employs sensor data produced by sensors in the smartphone to perform display device function.

10. The system as recited in claim 1, wherein an operating system in the smartphone supports multi-tasking to enable independent use of the smartphone and the display device when the smartphone and the display device are coupled over a short-range communication link.

11. An apparatus, comprising:
a cellular wireless module;
a display;
a short-range module configured to
transmit image data received by the cellular wireless module, and
receive manually input data transmitted by a display device, wherein the apparatus is configured to respond to the manually input data; and
a processor unit configured to provide a processing function for the apparatus and the display device.

12. The apparatus as recited in claim 11, wherein the apparatus further comprises a graphic process module configured to compress the image data transmitted by the short-range module.

13. The apparatus as recited in claim 12, wherein the short-range module is configured to support a wireless communication link.

14. The apparatus as recited in claim 11, wherein the short-range module automatically attempts to establish a wireless connection with a display device to display data thereon.

15. An apparatus, comprising:
a display;
a display controller to process display data;
a human input interface device to enable an operator to manually input data to the apparatus; and
a short-range module configured to receive image data transmitted by a smartphone to enable the image to be displayed on the display, wherein the short-range module is further configured to transmit the manually input data, and wherein the apparatus employs a processor unit in the smartphone to provide a processing function to control the apparatus.

16. The apparatus as recited in claim 15, wherein the short-range module is configured to support a wireless communication link.

17. The apparatus as recited in claim 15, wherein the short-range module automatically establishes a short-range communication link with a smartphone to acquire image data to be displayed on the display.

18. The apparatus as recited in claim 15, wherein the apparatus is configured to operate in a mode independent of an operating mode of the smartphone.

19. A method of forming a system comprising:
forming a smartphone, comprising:
inserting a smartphone display into a smartphone housing,
coupling a processor unit to the smartphone display, and
coupling a smartphone short-range module to the processor to transmit image data for an image produced on the smartphone display, and
configuring the processor unit to provide a processing function to control the smartphone and a display device; and
forming the display device, comprising:
mounting a display device short-range module in the display device to receive the image data,
inserting a display device display into a display device housing,
coupling the display device display to the display device short-range module to display the image, and
coupling a human input interface device to the display device display to enable an operator to control the display device.

20. The method as recited in claim 19, further comprising:
coupling a smartphone graphic process module to the processor unit to compress the image data; and
coupling a display device graphic process module to the display device short-range module to decompress the image data.

21. A method comprising:
transmitting, by a smartphone, image data for an image produced on a smartphone display of the smartphone;
receiving at a display device the image data for the image produced on the smartphone display;
displaying the image at a display device display of the display device; and
controlling, by a processor in the smartphone, the smartphone and the display device.

22. The method as recited in claim 21, further comprising:
receiving, at the smartphone, manually input data transmitted by the display device; and
processing, at the smartphone, the manually input data.
